(19) United States
(12) Patent Application Publication
(10) Pub. No.: US 2008/0226962 A1
(43) Pub. Date: Sep. 18, 2008

(54) WATER RECYCLING SYSTEM

(75) Inventors: Nien-Hui Hsu, Hsinchu (TW); Jin-Shu Huang, Hsinchu (TW); Cheng Wang, Hsinchu (TW); Ching-Po Lee, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CORETRONIC CORPORATION, Hsinchu (TW)

(21) Appl. No.: 11/868,539

(22) Filed: Oct. 8, 2007

(30) Foreign Application Priority Data
Mar. 14, 2007 (TW) 96108700

(51) Int. Cl. H01M 2/00

(52) U.S. Cl. 429/34

(57) ABSTRACT

A water recycling system for recycling water produced by a fuel cell module is provided. The water recycling system includes a fan, a mixing tank, and a duct. The fan has an exhaust opening and a suction opening adjacent to a cathode of the fuel cell module. The fan is used to vaporize water produced by the fuel cell module into vapor and exhaust the vapor from the exhaust opening. The mixing tank has a fuel inlet and a fuel outlet. A fuel for the fuel cell module is injected into the mixing tank via the fuel inlet, and the fuel outlet is connected to the fuel cell module. The duct has a first end and a second end. The first end is connected to the exhaust opening, and the second end is in contact with the fuel inside the mixing tank.

### CROSS-REFERENCE TO RELATED APPLICATION

This application claims the priority benefit of Taiwan application serial no. 96108700, filed on Mar. 14, 2007. All disclosure of the Taiwan application is incorporated herein by reference.

### BACKGROUND OF THE INVENTION

1. Field of the Invention

The present invention relates to a fuel cell. More particularly, the present invention relates to a water recycling system for a fuel cell.

2. Description of Related Art

Fuel cells are a power technology in conformity with trend of the age due to advantages of high efficiency, low noise, and pollution free. Fuel cells can be separated into many categories which, among others, include proton exchange membrane fuel cells (PEMFCs) and direct methanol fuel cells (DMFCs). The fuel cell module of DMFC, for example, is composed of a proton exchange membrane and a cathode and an anode disposed at both sides of the proton exchange membrane.

The DMFC uses methanol aqueous solution as the fuel, and reaction formulae of the DMFC are as follows:

anode: CH₃OH+H₂O→CO₂+6H⁺+6e⁻

cathode: 3/2O₂+6H⁺+6e→3H₂O

overall reaction: CH₃OH+H₂O+3/2O₂→CO₂+3H₂O

It is known from the above reaction formulae that water (H₂O) is a reactant of the anode and also a product of the cathode. If the water produced at the cathode can be effectively used by the anode, the overall volume of the fuel cell can be reduced effectively. In addition, the methanol aqueous solution in the DMFC must maintain a certain concentration, so as to prevent a serious problem of methanol crossover that will reduce the efficiency and life of the fuel cell. Usually, methanol fuel cans are filled with pure methanol or high-concentration methanol aqueous solution for supplement of the fuel required in the reaction of the fuel cell in time, and the water produced by the cathode reaction is recycled to maintain the certain concentration of methanol aqueous solution. Therefore, the overall volume of the fuel cell can be effectively reduced by using high-concentration methanol aqueous solution and a fine water recycling system.

FIG. 1 is a schematic view of a water recycling system of a conventional fuel cell. Referring to FIG. 1, the conventional water recycling system 100 includes two fans 110, 120, a heat exchanger 130, and a mixing tank 140. The mixing tank 140 is used to accommodate methanol aqueous solution left after reaction, the product (CO₂) of the anode, and the product (water) of the cathode. The mixing tank 140 has a fuel inlet 142 and a fuel outlet 144. High-concentration methanol aqueous solution 20 and the remainder methanol aqueous solution left after reaction are injected into the mixing tank 140 via the fuel inlet 142, and the fuel outlet 144 is connected to a fuel cell module 80. The fan 110 is adjacent to a cathode (not shown) of the fuel cell module 80, so as to vaporize the water produced by the cathode reaction of the fuel cell module 80 into vapor, and to blow the vapor into the heat exchanger 130. The fan 120 blows air to fins 132 of the heat exchanger 130, so as to keep temperature of the heat exchanger 130 near the ambient temperature, so that the temperature of the vapor entering the heat exchanger 130 is higher than that of the heat exchanger 130.

As described above, a saturation vapor pressure of the vapor is higher at a higher temperature, i.e., a vapor content in high-temperature air is higher than that in low-temperature air. Therefore, when the high-temperature vapor flows through the heat exchanger 130, the temperature is lowered, and the saturation vapor pressure is reduced accordingly. At this time, the vapor is condensed into liquid water in the heat exchanger 130. The heat exchanger 130 has at least one opening at a bottom 134 thereof, for the liquid water to drop into the mixing tank 140 and being mixed with the high-concentration methanol aqueous solution 20 to form the methanol aqueous solution with an appropriate concentration.

The conventional water recycling system 100 has a lot of components, so the volume of the water recycling system 100 is relatively large. And, the water recycling system 100 additionally needs the fan 120 and the heat exchanger 130 to condense the vapor into the liquid water. As the fan 120 will consume electric power generated by the fuel cell module 80, an output power of the fuel cell module 80 will be lowered. In addition, the conventional water recycling system 100 requires two operating components (i.e., the fans 110 and 120), so the reliability of the water recycling system 100 is poor. Moreover, the temperature difference between the vapor entering the heat exchanger 130 and the heat exchanger 130 is limited, and the contact area between them is also limited. Therefore, the heat exchange performance is not satisfying, and the water recycling rate is low. That is, the conventional water recycling system 100 has a low water recycling efficiency. Further, the mixing tank 140 must be open-type mixing tank allowing the water to drop into the mixing tank, so the methanol aqueous solution 20 in the mixing tank 140 may leak, and the methanol aqueous solution 20 is easy to evaporate and cannot be used.

### SUMMARY OF THE INVENTION

The present invention is directed to a water recycling system with a small volume.

The present invention is directed to a water recycling system for improving output power of a fuel cell and reaction efficiency of a fuel cell.

One embodiment of the present invention provides a water recycling system for recycling water produced by a fuel cell module. The water recycling system includes a fan, a mixing tank, and a duct. The fan has an exhaust opening and a suction opening adjacent to a cathode of the fuel cell module. The fan is used to vaporize the water produced by the fuel cell module into vapor and exhaust the vapor from the exhaust opening. The mixing tank has a fuel inlet and a fuel outlet. A fuel is injected into the mixing tank via the fuel inlet, and the fuel outlet is connected to the fuel cell module. The duct has a first end and a second end. The first end is connected to the exhaust opening, and the second end is in contact with the fuel inside the mixing tank.

Another embodiment of the present invention further provides a water recycling system for recycling water produced by a fuel cell module. The water recycling system includes a fan, a mixing tank, a duct, and a valve. The fan has an exhaust opening and a suction opening adjacent to a cathode of the fuel cell module. The fan is used to vaporize the water produced by the fuel cell module into vapor and exhaust the vapor from the exhaust opening. The mixing tank has a fuel inlet and a fuel outlet. The fuel inlet is adapted to receive fuel injected into the mixing tank via the fuel inlet, and the fuel outlet is connected to the fuel cell module. The duct has a first end and a second end. The first end is connected to the exhaust opening, and the second end is connected to the mixing tank and is spaced by a distance from a liquid surface of the fuel inside the mixing tank. The valve is disposed on a sidewall of the duct, and is driven by gas flowing inside the duct to open and close.

Yet another embodiment of the present invention further provides a water recycling system for recycling water produced by a fuel cell module. The water recycling system includes a fan, a closed mixing tank, and a duct. The fan has an exhaust opening and a suction opening adjacent to a cathode of the fuel cell module. The fan is used to vaporize the water produced by the fuel cell module into vapor and exhaust the vapor from the exhaust opening. A lower portion of the closed mixing tank has a fuel inlet and a fuel outlet, and an upper portion of the closed mixing tank has a gas inlet and a gas outlet. The fuel inlet is adapted to receive fuel injected into the closed mixing tank via the fuel inlet, and the fuel outlet is connected to the fuel cell module. The duct has a first end and a second end. The first end is connected to the exhaust opening, and the second end is connected to the gas inlet.

The water recycling system of the embodiment according to the present invention needs only one fan, and does not need a heat exchanger additionally. Thus, the volume of the water recycling system is reduced, and the output power of the fuel cell using the water recycling system is improved. Moreover, the present invention uses the heat generated by cathode reaction to raise the temperature of the fuel, so the reaction efficiency of the fuel cell using the water recycling system can be improved.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a water recycling system of a conventional fuel cell.

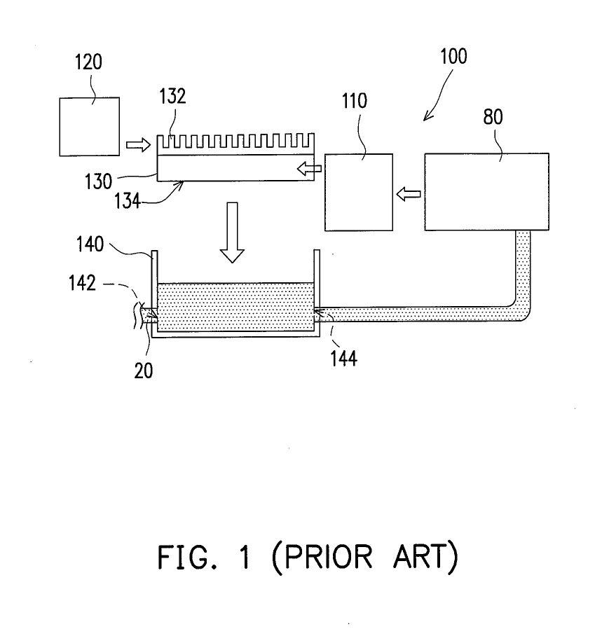

FIG. 2 is a schematic view of a water recycling system according to a first embodiment of the present invention.

FIG. 3 is a schematic view of another water recycling system according to the first embodiment of the present invention.

FIGS. 4A and 4B are schematic views of a water recycling system according to a second embodiment of the present invention.

FIGS. 5A and 5B are a side view and a top view of a water recycling system according to a third embodiment of the present invention, respectively.

FIGS. 6A-6C are schematic views of another three water recycling systems according to the third embodiment of the present invention.

FIG. 7A is a top view of another closed mixing tank according to the third embodiment of the present invention.

FIG. 7B is a side view of another closed mixing tank according to the third embodiment of the present invention.

FIG. 8 is a schematic view of another closed mixing tank according to the third embodiment of the present invention.

FIG. 9 is a schematic view of another water recycling system according to the third embodiment of the present invention.

### DESCRIPTION OF EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected” and variations thereof herein are used broadly and encompass direct and indirect connections. Similarly, “adjacent to” and variations thereof herein are used broadly and encompass directly and indirectly “adjacent to”. Therefore, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

### First Embodiment

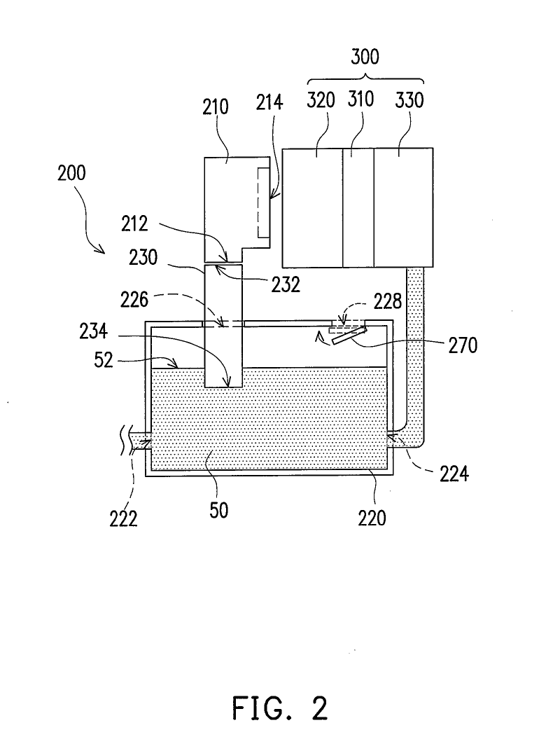

FIG. 2 is a schematic view of a water recycling system according to a first embodiment of the present invention. Referring to FIG. 2, the water recycling system 200 is used to recycle water produced by a fuel cell module 300. The fuel cell module 300 includes a proton exchange membrane 310, a cathode 320, and an anode 330. The proton exchange membrane 310 is disposed between the cathode 320 and the anode 330. The water recycling system 200 includes a fan 210, a mixing tank 220, and a duct 230. The fan 210 has an exhaust opening 212 and a suction opening 214, and the suction opening 214 is adjacent to the cathode 320 of the fuel cell module 300. The mixing tank 220 has a fuel inlet 222 and a fuel outlet 224. A fuel 50 is injected into the mixing tank 220 via the fuel inlet 222, and the fuel outlet 224 is connected to the fuel cell module 300. The duct 230 has a first end 232 and a second end 234. The first end 232 is connected to the exhaust opening 212, and the second end 234 is in contact with the fuel 50 inside the mixing tank 220.

The mixing tank 220 is, for example, a closed mixing tank, but may also be an open-type mixing tank. An upper portion of the mixing tank 220 has a gas inlet 226 and a gas outlet 228. More specifically, the gas inlet 226 and the gas outlet 228 are located at a top of the mixing tank 220. The duct 230 is inserted into the mixing tank 220 via the gas inlet 226, such that the second end 234 of the duct 230 is in contact with the fuel 50 in the mixing tank 220. The duct 230, for example, is perpendicular to a liquid surface 52 of the fuel 50. In addition, the water recycling system 200 may further include a back pressure valve 270 disposed at the gas outlet 228, so as to prevent the fuel 50 from flowing out via the gas outlet 228.

In this embodiment, the high-concentration fuel 50 is injected into the mixing tank 220, and is diluted to have an appropriate concentration. Then, the fuel 50 in the mixing tank 220 is injected to the anode 330 of the fuel cell module 330 for performing reaction. The fan 210, for example, is a blower for vaporizing the water produced by the cathode reaction of the fuel cell module 300 into vapor. The vapor is sucked by the fan 210 from the suction opening 214, and is exhausted into the duct 230 from the exhaust opening 212. Then, the vapor is exhausted from the second end 234 of the duct 230, and is in contact with the fuel 50.

As described above, the fuel cell module 300 generates heat during reaction, so the water produced in the reaction has a higher temperature. The vapor of a higher temperature is condensed into liquid water when getting in contact with the fuel 50 of a lower temperature. The liquid water is mixed with the fuel 50 to dilute the fuel 50 to have an appropriate concentration. As such, the recycling of water is completed.

As the water recycling system 200 of this embodiment is a closed water recycling system, so the water and the fuel 50 is prevented from flowing out, and the leakage of the vapor is avoided. Thus, the water recycling efficiency and the use efficiency of the fuel 50 of the water recycling system 200 are improved, and the safety of the fuel cell using the water recycling system 200 is improved. Moreover, the fuel 50 of lower temperature absorbs the heat of vapor when the vapor of higher temperature is in contact with the fuel 50 of lower temperature. Therefore, the temperature of the fuel 50 is raised, thus improving the reaction efficiency of the fuel cell module 300.

As described above, compared with the conventional art, the water recycling system 200 of this embodiment does not need the heat exchanger and the fan for cooling the heat exchanger additionally, so the volume of the water recycling system 200 is reduced, and the output power of the fuel cell module 300 is increased. Moreover, compared with the conventional art, one operating component is omitted in the water recycling system 200, so the reliability is improved. Further, as the duct 230 is perpendicular to the liquid surface 52 of the fuel 50 in the mixing tank 220, the effect of impact cooling is improved to condense more vapor into liquid water, thus improving the water recycling efficiency.

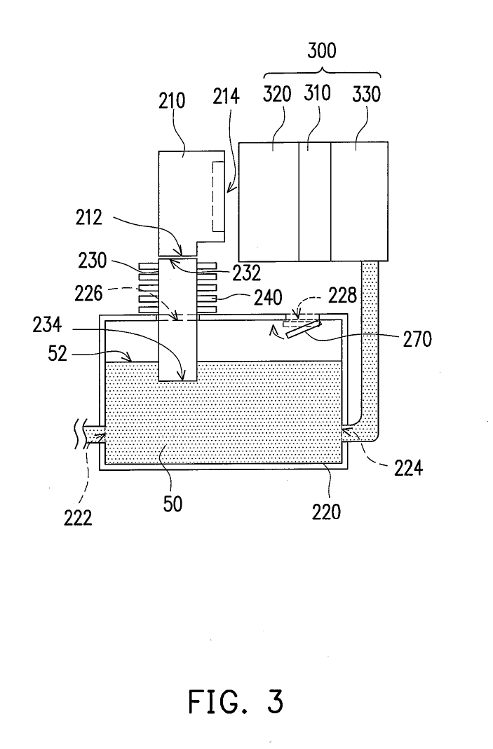

It should be noted that the material of the duct 230 may be a metal or another material with a high conductivity coefficient, so as to facilitate heat dissipation of the high-temperature vapor, and to condense vapor into liquid water. Besides, a plurality of fins 240 can be disposed on the outer surface of the duct 230 (as shown in FIG. 3), so as to improve the heat dissipation effect of the duct 230.

### Second Embodiment

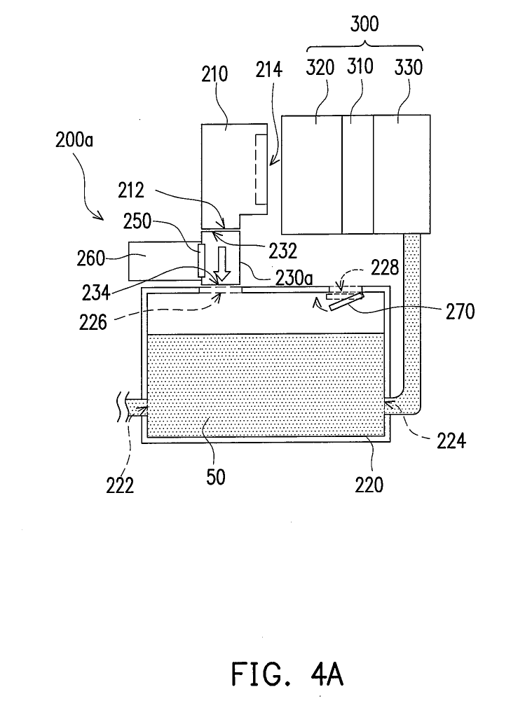

FIGS. 4A and 4B are schematic views of a water recycling system according to a second embodiment of the present invention. Referring to FIGS. 4A and 4B, the water recycling system 200a is similar to the water recycling system 200 of the first embodiment, so only the differences therebetween are described below. The second end 234 of the duct 230a of the water recycling system 200a is not in contact with the fuel 50. In detail, the second end 234 of the duct 230a is located at the gas inlet 226 of the mixing tank 220, and is spaced by a distance from the liquid surface 52 of the fuel 50 inside the mixing tank 220. Moreover, the water recycling system 200a further includes a valve 250 disposed on a sidewall of the duct 230a. The sidewall of the duct 230a may be connected to a bypass duct 260, and the valve 250 is located at the junction of the duct 230a and the bypass duct 260.

The gas flowing inside the duct 230a drives the valve 250 to open or close. In detail, the wind pressure P of the gas (vapor) blown into the duct 230a by the fan 210 can be divided into a dynamic pressure P_{d} and a static pressure Pₛ. The dynamic pressure P_{d} is relevant to the velocity of the fluid, and the static pressure Pₛ is the pressure on the sidewall of the duct 230a applied by the fluid. Referring to FIG. 4A, when the liquid surface 52 in the mixing tank 220 is at a predetermined height, as the distance between the second end 234 of the duct 230a and the liquid surface 52 is large, the resistance during the gas flows is relatively low. At this time, the flowing velocity of the gas driven by the fan 210 is high, so the dynamic pressure P_{d} is high, and the static pressure Pₛ is low. Thus, the static pressure Pₛ applied on the sidewall of the duct 230a is lower than the pressure Pᵥ required to open the valve 250, so the valve 250 is turned off. The gas directly impacts the liquid surface 52 in the mixing tank 220, such that the vapor is condensed into liquid water.

Referring to FIG. 4B, when the liquid surface in the mixing tank 220 rises gradually, as the distance between the second end 234 of the duct 230a and the liquid surface 52 becomes smaller gradually, the resistance during the gas flows increase gradually. Therefore, the flowing velocity of the gas driven by the fan 210 is reduced gradually, i.e., the dynamic pressure P_{d} is reduced gradually, and the static pressure Pₛ rises gradually. When the static pressure Pₛ is higher than the pressure Pᵥ required to open the valve 250, the valve 250 is turned on, such that a portion of the gas flows out through the bypass duct 260, and does not enter the mixing tank 220. Thus, the leakage of the fuel 50 in the mixing tank 220 is prevented. Moreover, when the fuel 50 in the mixing tank 220 is consumed gradually to gradually lower the liquid surface 52, the flowing velocity of gas increases gradually, i.e., the dynamic pressure P_{d} rises gradually, and the static pressure Pₛ is reduced gradually. When the static pressure PS is lower than the pressure Pᵥ required to open the valve 250, the valve 250 is turned off, such that the gas enters the mixing tank 220.

Therefore, the water recycling system 220a of this embodiment uses the gas flowing in the duct 230a to drive the valve 250 to open and close, so as to adjust the height of the liquid surface 52 in the mixing tank 220 automatically. Moreover, a selective filter apparatus (not shown) can be disposed at the gas outlet 228 of the mixing tank 220. The selective filter apparatus blocks the liquid and allows the gas to pass through. In addition, other advantages of the water recycling system 200a are similar to those of the water recycling system 200 according to the first embodiment, and will not be described here again.

### Third Embodiment

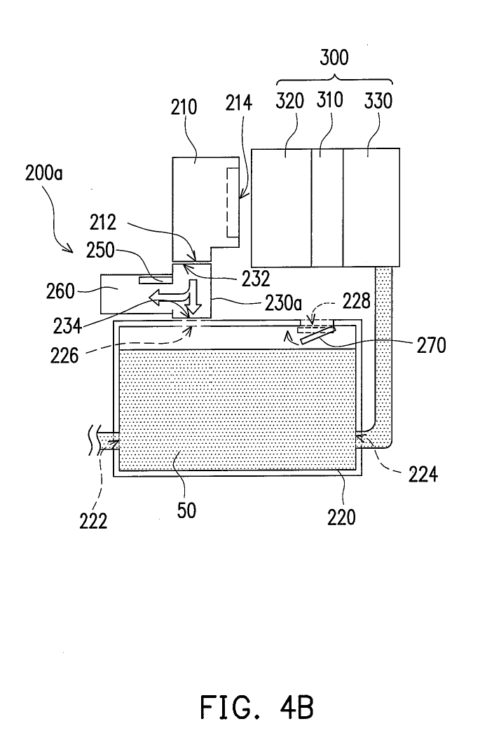

FIGS. 5A and 5B are schematic side and top views of a water recycling system according to a third embodiment of the present invention. Referring to FIGS. 5A and 5B, the water recycling system 400 of this embodiment includes a fan 410, a closed mixing tank 420, and a duct 430. The fan 410 has an exhaust opening 412 and a suction opening 414, and the suction opening 414 is adjacent to a cathode of a fuel cell module (not shown). The closed mixing tank 420 has a fuel inlet 422 and a fuel outlet 424 at the bottom, and has a gas inlet 426 and a gas outlet 428 at the top. A fuel 50 is injected into the closed mixing tank 420 via the fuel inlet 422, and the fuel outlet 424 is connected to the fuel cell module. The duct 430 has a first end 432 and a second end 434. The first end 432 is connected to the exhaust opening 412, and the second end 434 is connected to the gas inlet 426.

The fan 410, for example, is a blower for vaporizing the water produced by the cathode reaction of the fuel cell module into vapor. The vapor is sucked by the fan 410 from the suction opening 414, and is exhausted into the duct 430 from the exhaust opening 412. Then, the vapor is exhausted from the second end 434 of the duct 430, and enters an upper portion of the closed mixing tank 420 from the gas inlet 426.

As described above, an interior space of the upper portion of the closed mixing tank 420 is a gas flow space, and an interior space of a lower portion of the closed mixing tank 420 is a liquid flow space. The temperature in the gas flow space is approximately an ambient temperature. The high-temperature vapor when flowing in the gas flow space is condensed into liquid water. The liquid water drops into the liquid flow space, so as to dilute the fuel 50 injected into the closed mixing tank 420 to have an appropriate concentration. Thus, the recycling of water is completed.

In order to improve the condensation efficiency of the vapor in the gas flow space, a plurality of heat dissipation components 440 can be disposed in the gas flow space. An extending direction of the duct 430 is, for example, perpendicular to an extending direction of each heat dissipation components 440. The material of the heat dissipation components 440 may be metal (e.g., aluminum, copper, and the like) or another material of a high thermal conductivity coefficient. Moreover, the heat dissipation components 440 may use stainless steel as a base material on which a film is coated for preventing the corrosion of the fuel 50. The material of the coated film can be carbon tetrafluoride. In addition, the heat dissipation components 440 shown in FIG. 5B are plate-shaped. However, the heat dissipation components can also be pin-shaped. Moreover, in this embodiment, the heat dissipation components 440 can form a serpentine flow channel in the gas flow space, so as to increase the time that the high-temperature vapor flows in the gas flow space, such that the heat dissipation components 440 condense more vapor into liquid water. Thus, the water recycling efficiency is improved.

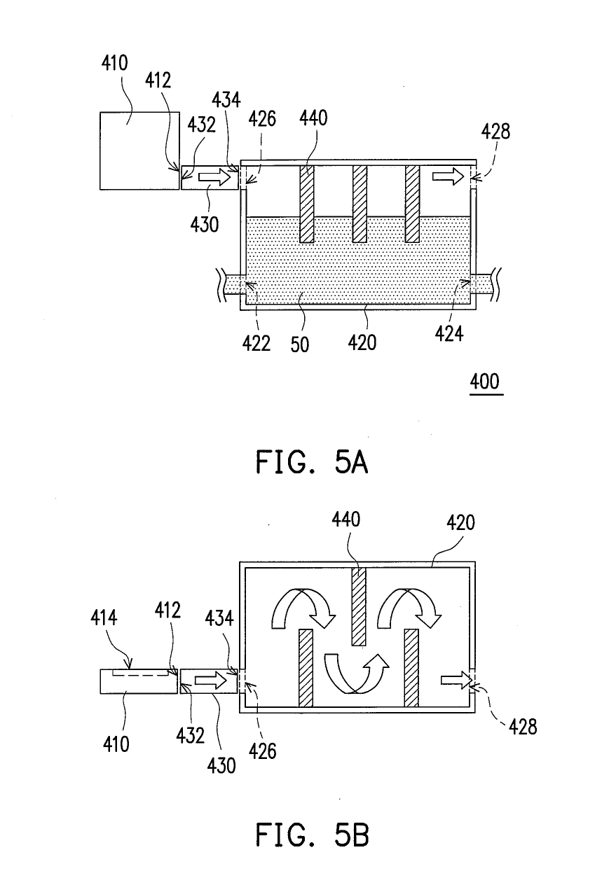

As described above, the heat dissipation components 440, for example, are connected to a top of the closed mixing tank 420. The heat dissipation components 440 may extend into the liquid flow space or not extend into the liquid flow space. The heat dissipation components 440 may also protrude outside the top of the closed mixing tank 420 (as shown in FIG. 6A). Thus, the heat dissipation components 440 dissipate the heat outside the closed mixing tank 420, and the water recycling efficiency is improved. Moreover, the heat dissipation components 440 can be merely connected to a bottom of the closed mixing tank 420 (as shown in FIG. 6B). In another embodiment shown in FIG. 6C, alternatively, a part of the heat dissipation components 440 are connected to the top of the closed mixing tank 420, while the other part of the heat dissipation components 440 are connected to the bottom of the closed mixing tank 420. In addition, the heat dissipation components 440 shown in FIG. 5B can be merely connected to the sidewall of the closed mixing tank 420.

If the material of the closed mixing tank 420 is a metal, the heat dissipation components 440 may extend from the wall of the closed mixing tank 420. In other words, the heat dissipation components 440 and the closed mixing tank 420 may be one-piece formed.

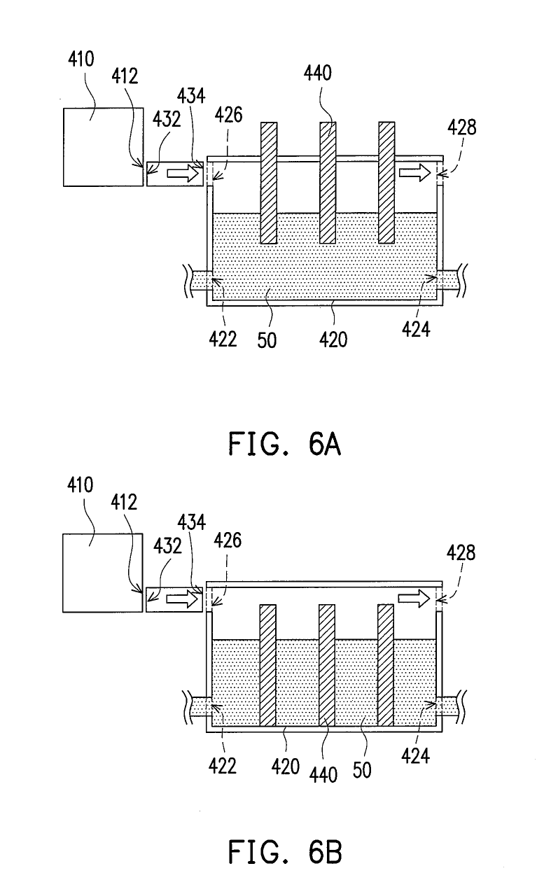

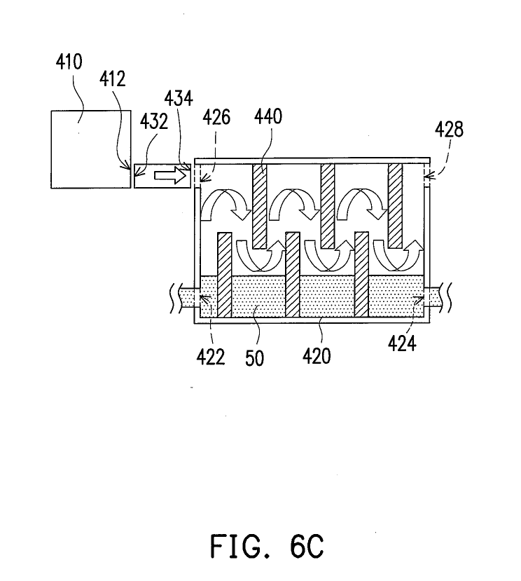

In the present invention, the closed mixing tank may additionally have fluid guide plates, which are described as follows. FIG. 7A is a top view of another closed mixing tank according to the third embodiment of the present invention, and FIG. 7B is a side view of still another closed mixing tank according to the third embodiment of the present invention. Referring to FIG. 7A, a plurality of fluid guide plates 450 is disposed in the closed mixing tank 420a, so as to form a serpentine flow channel in the gas flow space. Thus, the time that the high-temperature vapor flows in the liquid flow space is increased, and the water recycling efficiency is improved.

The fluid guide plates 450, for example, are connected to the top and/or sidewall of the closed mixing tank 420a. Moreover, the material of the fluid guide plates 450 may be a material of a high thermal conductivity coefficient, such as copper, aluminum, or other metals. In other words, the fluid guide plates 450 may serve as the heat dissipation components. If the material of the fluid guide plates 450 is a material of a low thermal conductivity coefficient, additional heat dissipation components (not shown) may be disposed in the gas flow space, so as to condense more vapor, and further to improve the water recycling efficiency. Moreover, the fluid guide plates 450 may also be connected to the top and the bottom of the closed mixing tank 420a (as shown in FIG. 7B).

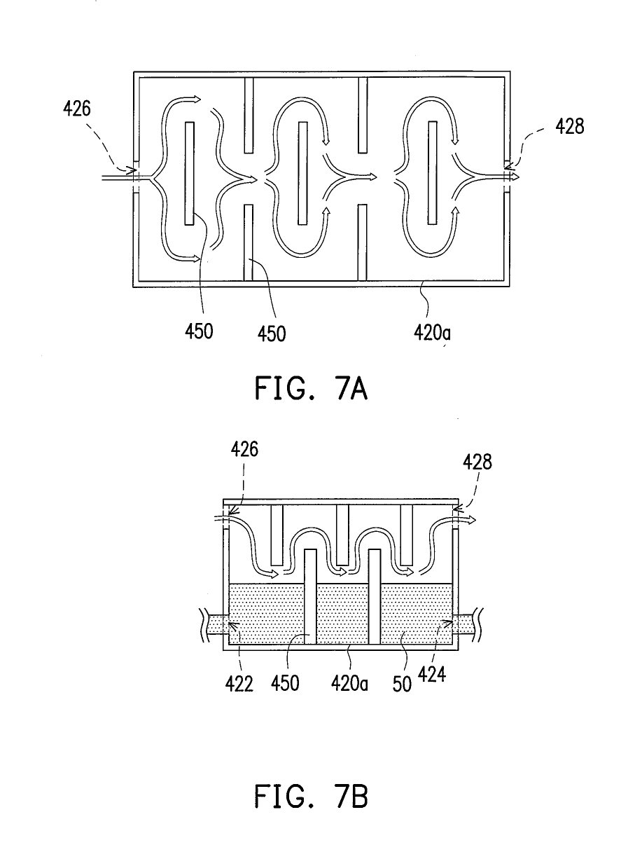

In the present invention, the closed mixing tank may also comprise two tank bodies, which are described as follows. FIG. 8 is a schematic view of another closed mixing tank according to the third embodiment of the present invention. Referring to FIG. 8, the upper portion of the closed mixing tank 420b is a tank body 421, and the lower portion of the closed mixing tank 420b is another tank body 423. The gas inlet 426 and the gas outlet 428 are arranged on the sidewall of the tank body 421, and the fuel inlet 422 and the fuel outlet 424 are arranged on the sidewall of the tank 423. The space in the tank 421 is the gas flow space, and the space in the tank body 423 is the liquid flow space. Moreover, the junction of the tank body 421 and the tank body 423 has at least one opening (not shown), such that the liquid water condensed in the gas flow space flows into the liquid flow space.

In this embodiment, the design of two tank bodies 421 and 423 is adopted. Thus, less fuel 50 in the tank 423 is vaporized and enters the tank 421, so the use efficiency of the fuel 50 is improved. Furthermore, the material of the tank 421 may be a material of a high thermal conductivity coefficient, such as copper, aluminum, or other metals, such that more vapor is condensed and the water recycling efficiency can be improved.

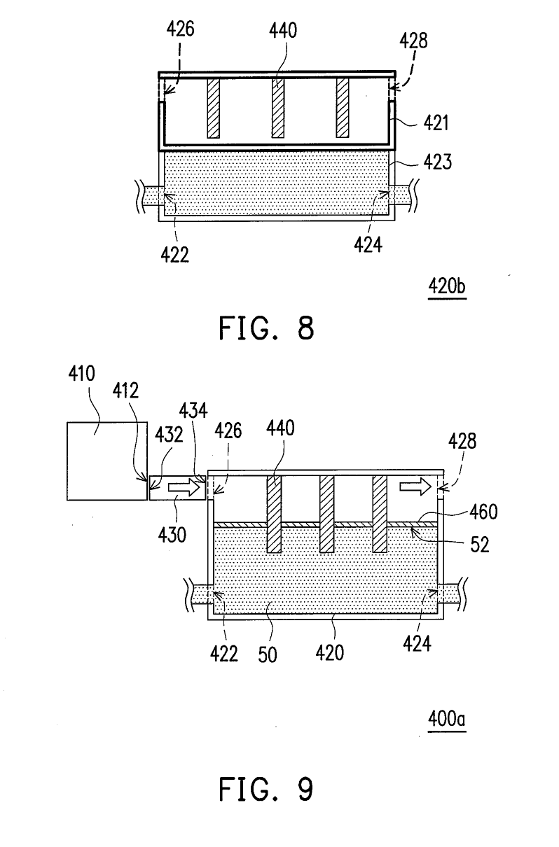

FIG. 9 is a schematic view of another water recycling system according to the third embodiment of the present invention. Referring to FIG. 9, compared with the water recycling system 400 of FIG. 5A, the water recycling system 400a further includes a cover film 460. The cover film 460 is disposed at the junction of the gas flow space and the liquid flow space, so as to prevent the vaporization of the fuel 50. In detail, the cover film 460 is floated on the liquid surface 52 of the fuel 50, or is fixed onto the sidewall of the closed mixing tank 420. Moreover, the cover film 460 has at least one opening (not shown), such that the liquid water condensed in the gas flow space flows into the liquid flow space. In addition, the material of the cover film 460 may be a material, such as polyimide, which can prevent the corrosion of the fuel 50.

To sum up, the water recycling system according to the present invention has at least one or more of the following advantages.

1. The water recycling system of the present invention needs only one fan, and does not additionally use the heat exchanger, so the volume of the water recycling system is reduced, and the manufacturing cost is lowered.

2. Compared with the conventional art, the water recycling system of the present invention uses only one fan, thus consuming less power and increasing the output power of the fuel cell module.

3. The present invention uses the heat generated by the cathode reaction to increase the temperature of the fuel, so the reaction efficiency of the fuel cell is improved.

4. As the water recycling system of the present invention includes fewer components, so the volume is smaller.

5. The mixing tank of the water recycling system of the present invention may be a closed mixing tank, so the leakage of water and fuel is prevented, and the water recycling efficiency and the safety of the fuel cell are improved.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A water recycling system, for recycling water produced by a fuel cell module, comprising:
a fan, having an exhaust opening and a suction opening adjacent to a cathode of the fuel cell module, wherein the fan vaporizes the water produced by the fuel cell module into vapor, and exhausts the vapor from the exhaust opening;
a mixing tank, having a fuel inlet and a fuel outlet, wherein a fuel is injected into the mixing tank via the fuel inlet, and the fuel outlet is connected to the fuel cell module; and
a duct, having a first end and a second end, wherein the first end is connected to the exhaust opening, and the second end is in contact with the fuel inside the mixing tank.

2. The water recycling system as claimed in claim 1, wherein the mixing tank is a closed tank, an upper portion of the mixing tank has a gas inlet and a gas outlet, and the duct is inserted into the mixing tank via the gas inlet.

3. The water recycling system as claimed in claim 2, further comprising a selective filter apparatus disposed at the gas outlet, wherein the selective filter apparatus blocks liquid and allows gas to pass through.

4. The water recycling system as claimed in claim 2, further comprising a back pressure valve disposed at the gas outlet.

5. The water recycling system as claimed in claim 1, wherein a plurality of fins is disposed on an outer surface of the duct.

6. The water recycling system as claimed in claim 1, wherein the duct is perpendicular to a liquid surface of the fuel.

7. A water recycling system, for recycling water produced by a fuel cell module, comprising:
a fan, having an exhaust opening and a suction opening adjacent to a cathode of the fuel cell module, wherein the fan vaporizes the water produced by the fuel cell module into vapor, and exhausts the vapor from the exhaust opening;
a mixing tank, having a fuel inlet and a fuel outlet, wherein a fuel is injected into the mixing tank from the fuel inlet, and the fuel outlet is connected to the fuel cell module;
a duct, having a first end and a second end, wherein the first end is connected to the exhaust opening, and the second end is connected to the mixing tank and is spaced by a distance from a liquid surface of the fuel inside the mixing tank; and
a valve, disposed on a sidewall of the duct, and driven by gas flowing inside the duct to open and close.

8. The water recycling system as claimed in claim 7, wherein the mixing tank is a closed tank, an upper portion of the mixing tank has a gas inlet and a gas outlet, and the second end of the duct is connected to the gas inlet.

9. The water recycling system as claimed in claim 8, further comprising a selective filter apparatus disposed at the gas outlet, wherein the selective filter apparatus blocks liquid and allows gas to pass through.

10. The water recycling system as claimed in claim 8, further comprising a back pressure valve disposed at the gas outlet.

11. The water recycling system as claimed in claim 7, wherein a plurality of fins is disposed on an outer surface of the duct.

12. The water recycling system as claimed in claim 7, wherein the duct is perpendicular to a liquid surface of the fuel.

13. The water recycling system as claimed in claim 7, further comprising a bypass duct connected to the duct, wherein the valve is located at a junction of the duct and the bypass duct.

14. A water recycling system, for recycling water produced by a fuel cell module, comprising:
a fan, having an exhaust opening and a suction opening adjacent to a cathode of the fuel cell module, wherein the fan vaporizes the water produced by the fuel cell module into vapor, and exhausts the vapor from the exhaust opening;
a closed mixing tank, a lower portion of the closed mixing tank having a fuel inlet and a fuel outlet, and an upper portion of the closed mixing tank having a gas inlet and a gas outlet, wherein a fuel is injected into the closed mixing tank via the fuel inlet, and the fuel outlet is connected to the fuel cell module; and
a duct, having a first end and a second end, wherein the first end is connected to the exhaust opening, and the second end is connected to the gas inlet.

15. The water recycling system as claimed in claim 14, wherein an interior space of the upper portion of the closed mixing tank is a gas flow space, an interior space of the lower portion of the closed mixing tank is a liquid flow space, and a plurality of heat dissipation components is disposed in the gas flow space.

16. The water recycling system as claimed in claim 15, wherein the heat dissipation components are connected to a top of the closed mixing tank.

17. The water recycling system as claimed in claim 15, wherein the heat dissipation components are connected to a bottom of the closed mixing tank.

18. The water recycling system as claimed in claim 15, wherein a plurality of fluid guide plates is arranged in the closed mixing tank, for forming a serpentine flow channel in the gas flow space.

19. The water recycling system as claimed in claim 15, further comprising a cover film disposed at a junction of the gas flow space and the liquid flow space and having at least one opening.

20. The water recycling system as claimed in claim 15, wherein the upper portion of the closed mixing tank is a tank body, and the lower portion of the closed mixing tank is another tank body, and a junction of the tanks has at least one opening.

21. The water recycling system as claimed in claim 15, wherein an extending direction of the duct is perpendicular to an extending direction of each heat dissipation component.

22. The water recycling system as claimed in claim 15, wherein the heat dissipation components form a serpentine flow channel in the gas flow space.
